(19) United States
(12) Patent Application Publication
(10) Pub. No.: US 2014/0157818 A1
(43) Pub. Date: Jun. 12, 2014

(54) Permanent Magnet Generator Voltage Regulation

(71) Applicant: Jeffrey J. Burchill, Syracuse, NY (US)

(72) Inventor: Jeffrey J. Burchill, Syracuse, NY (US)

(73) Assignee: Carrier Corporation, Farmington, CT (US)

(21) Appl. No.: 14/127,577

(22) PCT Filed: Jun. 26, 2012
(86) PCT No.: PCT/US12/44185

§ 371 Date: Dec. 19, 2013

Related U.S. Application Data
(60) Provisional application No. 61/501,399, filed on Jun. 27, 2011.

(51) Int. Cl. H02P 9/04

(52) U.S. Cl. CPC H02P 9/04
USPC 62/467; 290/40 B

(57) ABSTRACT

A power generating system includes a power generation portion. The power generation portion includes a permanent magnet (PM) generator configured to operate in at least two speeds, and a voltage regulator in communication with the PM generator. The voltage regulator is disposed to regulate power output from the PM generator by configuring the PM generator to operate at a desired speed of the at least two speeds.

### FIELD OF INVENTION

The subject matter disclosed herein relates generally to the field of electrical power generation, and more particularly to voltage regulation in power generation systems.

### DESCRIPTION OF RELATED ART

Generally, electrical power generation systems are based on induction generators disposed to generate electrical power in response to forced operation of the generators. The generated electrical power is then applied or communicated to any variety of electrically powered equipment. Depending upon the specifications of the electrically powered equipment there may be a particular range of voltage and/or frequency which may be safely applied. For example, according to ISO Standard 1496, set by the INTERNATIONAL ORGANIZATION FOR STANDARDIZATION, which is hereby incorporated by reference herein in its entirety, refrigerated transport containers must be powered at a specific operating envelope. For example, in order to accommodate other components that may need to be added to the system/envelope (e.g., Diesel Particulate Filter), a smaller engine/generator is needed, in turn requiring greater efficiency. As such, accurate voltage regulation is essential to meeting these requirements.

### BRIEF SUMMARY

According to an example embodiment of the present invention, a power generating system includes a power generation portion. The power generation portion includes a permanent magnet (PM) generator configured to operate in at least two speeds, and a voltage regulator in communication with the PM generator. The voltage regulator is disposed to regulate power output from the PM generator by configuring the PM generator to operate at a desired speed of the at least two speeds.

According to an additional embodiment of the present invention, a method of voltage regulation of power output from a permanent magnet (PM) generator configured to operate in at least two speeds includes measuring power output at the PM generator, determining if the power output is within a predetermined range, and if the power output is above the predetermined range, reducing a speed of the PM generator to a lowest of the at least two speeds.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an electrical power generating system, according to an example embodiment; and

FIG. 2 illustrates a method of voltage regulation, according to an example embodiment.

### DETAILED DESCRIPTION

Embodiments of electrical power generating systems and methods of regulated voltage of said systems are described herein in detail. The electrical power generating systems may be used in supplying power to, for example, refrigerated freight containers when other power (i.e., terminal, mains, etc) is not available.

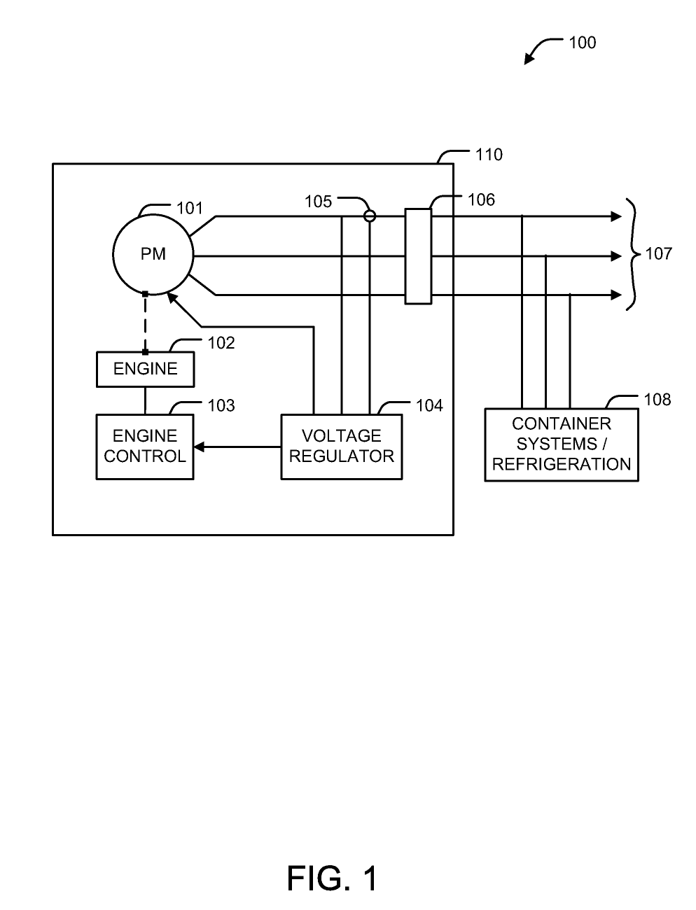

Turning to FIG. 1, an electrical power generating system is illustrated. The system 100 includes an electrical power generating portion 110 and a freight container/refrigeration portion 108 in electrical communication with the electrical power generating portion 110. The freight container/refrigeration portion 108 may include a freight container as described in ISO Standard 1496, and may include electrically powered refrigeration equipment configured to refrigerate the freight container in response to electrical power being applied from an external source and/or the electrical power generating portion 110.

The electrical power generating portion 110 includes a permanent magnet (PM) generator 101 in mechanical communication with an engine 102. The PM generator 101 may be any suitable permanent magnet generator rated to supply power according to a desired rating. The engine 102 may be any suitable arrangement of engine, for example, gasoline, diesel, turbine, or any other suitable arrangement.

The electrical power generating portion 110 further includes engine control 103 in operative communication with the engine 102. The engine control 103 may be an engine control apparatus or engine controller disposed and configured to control the operation of the engine 102. For example, the engine control 103 may be a computing apparatus configured to modify fuel/air mixtures applied to the engine 102, ignition characteristics of the engine 102, and/or any other suitable operating characteristics of the engine 102 such that the speed of the engine 102 is controlled by the engine control 103. According to example embodiments of the present invention, the engine control 103 is configured to operate the engine 102 in at least two different steady-state speed settings. For example, a high speed setting and a low speed setting. However, it should be readily understood that additional speed settings may be incorporated according to any desired implementation, and thus example embodiments should not be limited to exactly two speeds.

The electrical power generating portion 110 further includes voltage regulator 104 in communication with the PM generator 101 and the engine control 103. The voltage regulator 104 may be an electrical control apparatus configured to regulate/limit voltage overshoot of electrical power generated at the PM generator 101. For example, the voltage regulator 104 may be arranged as a negative-feedback control loop. This is facilitated through electrical communication between at least one phase output connection of the PM generator 101 and the voltage regulator 104 to accurately determine voltage output. Further, a current transducer 105 may provide current measurements from the at least one phase output to the voltage regulator 104. Thus, the characteristics of the power generated through electrical power generating portion 110 may be processed at the voltage regulator 104. If these characteristics vary from a predetermined or desired range, the voltage regulator 104 may communicate an appropriate speed change value to the engine control 103, which changes the speed accordingly. Further, the voltage regulator 104 may further regulate the voltage though suppression of excess voltage either directly at phase outputs 107 of the PM generator 101, or though voltage suppression at the PM generator 101.

The electrical power generating portion 110 further includes protective circuitry 106 disposed and configured to limit over-current/over-voltage scenarios on outputs 107 of the PM generator 101. For example, the protective circuitry 106 may include circuit breakers, fuses, protective relays, and/or any other suitable devices.

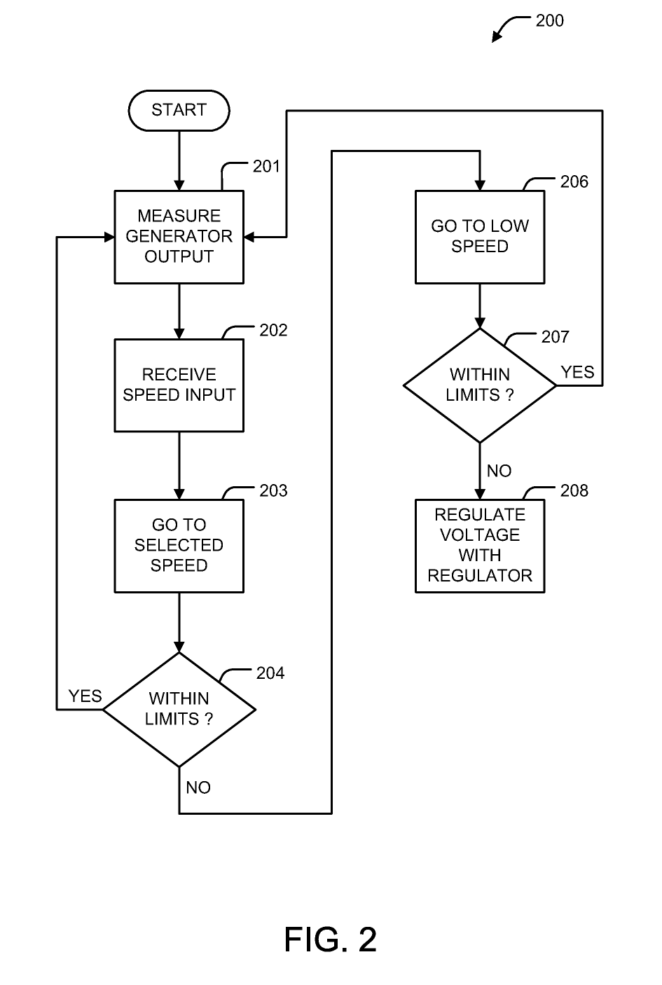

Hereinafter, methods of voltage regulation are described in detail with reference to FIG. 2

FIG. 2 illustrates a method of voltage regulation for PM generators, according to an example embodiment. The method 200 may be embodied as computer-executable instructions stored on a computer readable storage medium that, when executed by a computer processor or equivalent device, direct the device to perform the method 200. The method 200 may further be embodied as a control loop in a general purpose computer processor or a simplified computer processor (e.g., microcontroller, FPGA, etc.) which directs said processor to perform the method as described. Furthermore, the method may be embodied as any of the forms above and performed through the voltage regulator 104 thereby configuring the electrical power generating portion 110 to control the system 100 in a manner substantially similar to the method 200.

Turning to FIG. 2, the method 200 includes measuring the output of PM generator 101 at block 201. The measuring may include monitoring a frequency, current output, and/or voltage output through any of the communication mediums and/or connections illustrated in FIG. 1. Through measurement of the PM generator 101 output, accurate voltage regulation may be facilitated through the voltage regulator 104.

The method 200 further includes receiving speed input or feedback at block 202. The speed input may be received or calculated based on the frequency output of the PM generator 101, or may be received from the engine control 103. The speed may be compared to a target speed range which is termed a “limit” or “regulatory limit” herein. For example, if the system 100 is to be implemented according to the ISO standards noted above, it may be desirable to compare the speed to the desired range and in response, configure the system 100 to operate at an adjusted speed. Further, the speed may be a selected speed of at least two available speeds for the engine 102. For example, the engine 102 may be configured to perform according to at least two pre-configured steady state speeds. The speed selection may be facilitated through direct user input at a user-interface (e.g., keypad, switch, etc) or through an automated process based on engine 102 efficiency. For example, if it is desirable to limit fuel consumption due to a low level of available fuel, an automated process may recommend a default speed which is relatively more efficient than a current speed of the engine 102.

The method 200 further includes configuring the engine 102 to operate at the selected speed at block 203. To configure the selected speed, the voltage regulator 104 may direct engine control 103 to adjust the engine 102 speed to match or operate relatively close to the selected speed.

The method 200 further includes determining if the actual output of the PM generator 101 is within limits as described above, at block 204. If the actual output is within limits, the method returns to block 201 to continue to monitor PM generator 101 output.

If the actual output is not within limits, the method 200 includes configuring the engine 102 to operate at a lower available speed, or in the case only two speeds are available, to operate at the lowest speed, at block 206. The configuration of speed occurs as described above.

The method 200 further includes determining if the actual output of PM generator 101 is within limits as described above, at block 207. If the actual output is within limits, the method 200 returns to block 201 to continue to monitor PM generator 101 output.

If the actual output is not within limits, the method 200 includes regulating voltage with any other voltage regulator available to the voltage regulator 104, at block 208. For example, and as described above, there may be power electronics, clamping, speed control, or other regulator means available within system 100 to facilitate voltage regulation in a relatively conventional manner. Furthermore, the operating characteristics of the PM generator 101 may be altered on the fly to facilitate voltage regulation. For example, PM generator output voltage is temperature-dependent. Generally, output voltage decreases with an increase in temperature at the PM generator. Therefore, voltage regulation may also be facilitated through cooling or heating the PM generator to change the output voltage.

This voltage regulation may be employed to correct any difference in actual output of PM generator 101 as compared to the desired limits described above. For example, if determined at block 207 that the PM generator 101 output is above the desired operating range, the voltage regulator 104 may regulate the PM generator 101 to reduce output. Further, if determined at block 207 that the PM generator 101 output is below the desired operating range, the voltage regulator 104 may configure the system 100 to operate at a higher available speed and utilize a different voltage regulation means to reduce the output of PM generator 101.

Upon reaching the desired output for PM generator 101, the method continues at block 201 to monitor output of PM generator 101.

As described above, example embodiments of the present invention may include systems and methods of regulating PM generator output thereby facilitating operation within desired limits. Through the use of a PM generator powered by a variable speed engine, the entire complexity of the control system may be reduced as many additional voltage regulation apparatuses including bulky power regulators may be omitted. This is beneficial in that costs and complexity may be reduced as compared to conventional systems.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1-17. (canceled)

18. A power generating system, comprising:
a power generation portion, wherein the power generation portion comprises:
a permanent magnet (PM) generator configured to operate in at least two speeds; and
a voltage regulator in communication with the PM generator, wherein the voltage regulator is disposed to regulate power output from the PM generator by configuring the PM generator to operate at a desired speed of the at least two speeds;
wherein the power generation portion further comprises an engine control in communication with the engine and the voltage regulator, wherein the engine control is configured to direct the engine to operate in one of the at least two speeds;
wherein the voltage regulator is configured to determine if the power output of the PM generator is within a predetermined range, and wherein if the power output of the PM generator is above or below the predetermined range the voltage regulator is configured to regulate voltage output of the PM generator.

19. The system of claim 18, wherein the power generation portion further comprises an engine in mechanical communication with the PM generator, wherein the engine is configured to operate at the at least two speeds of the PM generator.

20. The system of claim 18, wherein if the power output of the PM generator is above the predetermined range the voltage regulator is configured to direct the engine control to reduce the speed of the engine to a lowest of the at least two speeds.

21. The system of claim 18, wherein if the power output of the PM generator is below the predetermined range the voltage regulator is configured to direct the engine control to increase the speed of the engine to a highest of the at least two speeds.

22. The system of claim 18, further comprising a transport container, the transport container comprising an electrically powered refrigeration system configured to refrigerate contents of the transport container.

23. The system of claim 22, wherein the predetermined range is a range comprising predetermined values of proper operation of the refrigeration system, and wherein if the power output of the PM generator is above the predetermined range the voltage regulator is configured to reduce the speed of the PM generator to a lowest of the at least two speeds.

24. The system of claim 22, wherein the predetermined range is a range comprising predetermined values of proper operation of the refrigeration system, and wherein if the power output of the PM generator is below the predetermined range the voltage regulator is configured to increase the speed of the PM generator to a highest of the at least two speeds.

25. The system of claim 22, wherein the predetermined range is a range comprising predetermined values of proper operation of the refrigeration system.

26. A method of voltage regulation of power output from a permanent magnet (PM) generator configured to operate in at least two speeds, the method comprising:
measuring power output at the PM generator;
determining if the power output is within a predetermined range; and
if the power output is above the predetermined range, reducing a speed of the PM generator to a lowest of the at least two speeds; and
determining if the power output of the PM generator is within a predetermined range;
wherein if the power output of the PM generator is above or below the predetermined range, regulating voltage output of the PM generator.

27. The method of claim 26, further comprising:
receiving a desired speed of operation for the PM generator; and
directing the PM generator to operate at the desired speed.

28. The method of claim 27, further comprising:
measuring new power output at the PM generator operating at the desired speed;
determining if new the power output is within a predetermined range; and
if the power output is above the predetermined range, and the desired speed is a highest of the at least two speeds, reducing a speed of the PM generator to a lowest of the at least two speeds.

29. The method of claim 27, further comprising:
measuring new power output at the PM generator operating at the desired speed;
determining if new the power output is within a predetermined range; and
if the power output is above the predetermined range, and the desired speed is a lowest of the at least two speeds, reducing voltage output of the PM generator through voltage regulation.

30. The method of claim 27, wherein the desired speed is only one of the at least two desired speeds.

31. The method of claim 27, wherein the PM generator is in operative communication with a voltage regulator configured to perform the method of claim 26, and wherein the desired speed is received from a user interface in operative communication with the voltage regulator.

32. The method of claim 26, wherein the PM generator is in operative communication with a voltage regulator configured to perform the method of claim 26, and the voltage regulator is configured to direct the PM generator to operate in one of the at least two speeds.
